(19) United States
(12) Patent Application Publication
(10) Pub. No.: US 2009/0283370 A1
(43) Pub. Date: Nov. 19, 2009

(54) Immobilizer for Shopping Carts

(76) Inventors: Horst Sonnendorfer, Puchheim (DE); Franz Wieth, Puchheim (DE)

Correspondence Address: LERNER GREENBERG STEMER LLP, P O BOX 2480, HOLLYWOOD, FL, 33022-2480, US

(21) Appl. No.: 12/302,218

(22) PCT Filed: May 18, 2007
(86) PCT No.: PCT/DE2007/000905

§ 371 Date: Mar. 4, 2009

(30) Foreign Application Priority Data
May 23, 2006 (DE) 20 2006 008 341.3

(51) Int. Cl. B62B 5/04

(52) U.S. Cl. 188/19

(57) ABSTRACT

Immobilizer for shopping trolleys which is activated and deactivated by means of magnetic forces, in which lower forces are required to deactivate the immobilizer than to activate it. This makes it possible for the immobilizer to be deactivated both by a “strong” magnetic strip, such as is used for activation, and by a “weak” magnetic strip. The “strong” magnetic strip is located at the boundary of the permissible region, and one or more “weak” magnetic strips are located within the permissible region in order to activate immobilizers which are located within the permissible region and are still activated for some reason or another.

### TECHNICAL FIELD

The invention relates to immobilizers for shopping carts which are activated and deactivated by means of magnetic forces.

### PRIOR ART

Such an immobilizer is known, for example, from German utility model 202004017400.6. Said document describes that an immobilizer in the roller wheels of a shopping cart which has been activated by the roller wheels passing a magnetic strip in the floor or ground can be deactivated again when the roller wheels pass such a magnetic strip in the floor or ground again.

The magnetic strip is provided at the boundary of the region in which the shopping cart may be used. If anyone leaves this permissible area, the roller wheels pass the magnetic strip and the immobilizer is activated.

If a shopping cart which is located outside the permissible region with its immobilizer activated is returned to the permissible region, the magnetic strip is passed again and the immobilizer is deactivated again.

It has become apparent that persons who move a shopping cart back into the permissible region from outside it lift up the shopping cart on one side since said shopping cart can then at least be maneuvered to a limited degree despite the activated immobilizer.

When the magnetic strip is passed in the floor or ground, the roller wheel on the raised side of the shopping cart is too far away from the magnetic strip to deactivate the immobilizer.

### DISCLOSURE OF THE INVENTION

### Technical Problem

The problem of the invention is to provide an immobilizer in which the users' behavior described above is taken into account and deactivation of the immobilizer functions more reliably.

### Technical Solution

This problem is solved by means of an immobilizer in which smaller magnetic forces are necessary for the deactivation process than to activate the immobilizer.

### ADVANTAGEOUS EFFECTS

The solution according to the invention advantageously ensures that the immobilizer in a roller wheel which is located on the raised side of the shopping cart is deactivated despite the relatively large distance from the magnetic strip. The immobilizer according to the invention reacts more sensitively in the case of deactivation. This compensates the fact that a smaller magnetic force acts owing to the distance between the raised roller wheel and the magnetic strip.

A further advantageous effect is that an additional auxiliary magnetic strip can be used selectively to initiate a further deactivation process of the immobilizer. This auxiliary magnetic strip has a smaller magnetic force than the magnetic strip which is described above and which is provided at the boundary of the permissible region.

It has been found in practice that people will set a shopping cart which has been raised on one side back down again if the immobilizer is deactivated again at least on some of the roller wheel wheels after the magnetic strip has been passed.

In such a shopping cart, it is then often the case that only the immobilizer on one of the roller wheels is still activated and this still activated immobilizer can in fact be deactivated by means of the auxiliary magnetic strip.

The advantage of the invention is that roller wheels with a deactivated immobilizer can pass this auxiliary magnetic strip and nothing changes, but in contrast, a roller wheel with an activated immobilizer is deactivated.

These auxiliary magnetic strips can be located at various points within the permissible region and points which have a high probability of being passed when a shopping cart is used, for example the collecting areas, are suitable for this.

### BRIEF DESCRIPTION OF THE DRAWINGS

A possible exemplary embodiment of the invention will be explained in more detail below with reference to two figures, of which:

FIG. 1 shows an immobilizer according to the invention in the deactivated state, and

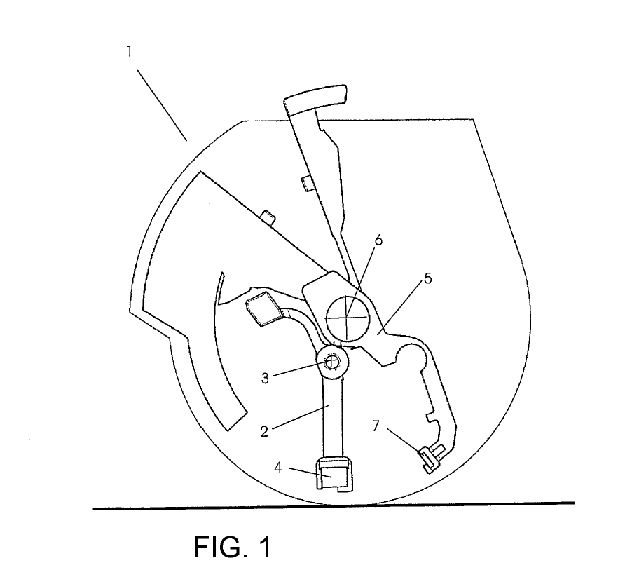

FIG. 2 shows the immobilizer from FIG. 1 in the activated state.

The immobilizer 1 comprises, in addition to other parts which are not illustrated for reasons of clarity, a lever 2 which is mounted so as to be movable about a pivoting point 3. The lever is fitted on one arm with a magnet 4.

The mechanism comprises a further lever 5 which is mounted so as to be rotatable about a pivoting point 6. At one end of the lever there is a magnet 7.

The position of this lever 5 is dependent on the operating state of the immobilizer. In the illustration shown, the immobilizer is in the deactivated state.

The basic method of function of the immobilizer can also be clarified by means of this highly simplified illustration: As soon as the roller wheel rolls over a magnetic strip, repelling forces are produced between the magnet 4 and the magnetic strip, which forces cause the lever 2 to pivot in the counterclockwise direction.

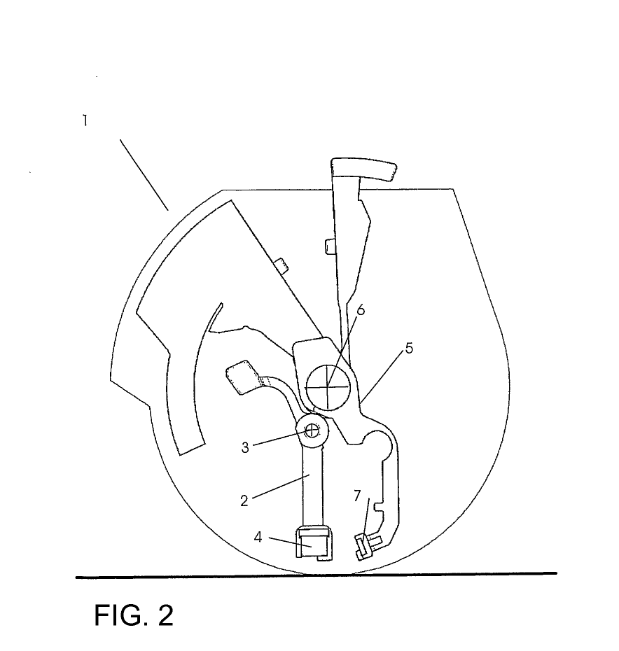

This pivoting of the lever 2 triggers a mechanical sequence (not illustrated in more detail) which leads to the activation of the immobilizer. The lever 2 subsequently returns to the position shown here, but the lever 5 is then in the position illustrated in FIG. 2.

FIG. 2 shows the activated state of the immobilizer. The lever 5 is rotated somewhat in the clockwise direction. As a result, the magnet 7 approaches the magnet 4 and as a result exerts a certain attractive force.

If the roller wheel is moved over a magnetic strip in this state, the repelling magnetic force which originates from the magnetic strip is combined with the magnetically attractive force which originates from the magnet 7.

In order to rotate the lever 2 in the counterclockwise direction, and therefore trigger the sequence which leads to the deactivation of the immobilizer, a smaller magnetically repelling force of the magnetic strip is necessary. A magnetic strip which is “weak” compared to the magnetic strip used for activation advantageously also brings about the deactivation in this way.

In this way it is possible for the immobilizer to be deactivated by a “strong” magnetic strip, such as is also used to activate the immobilizer, as well as by a “weak” magnetic strip.

The “strong” magnetic strips are located at the boundary of the permissible region. If a shopping cart leaves the permissible region, it passes the “strong” magnetic strip, as a result of which the immobilizer on the roller wheels of the shopping cart is activated.

As a result of the activation of the immobilizer, the steering angle is fixed at least two roller wheels, in which case the steering angle on each roller wheel is fixed at a different steering angle.

As a result, further travel of the shopping cart is impeded to a very great extent, for which reason said shopping cart is then usually abandoned after a short distance.

A shopping cart which has been abandoned outside the permissible region is, however, in turn often returned to the permissible region by another customer who would like to make purchases and therefore requires a shopping cart.

Since the shopping cart with the activated immobilizer is relatively easy to maneuver if only one of the roller wheels at which the steering angle is fixed touches the underlying surface, many customers raise the empty shopping cart on one side when bringing it back and therefore pass the “strong” magnetic strip.

The “strong” magnetic strip is therefore again further away from the immobilizer in the roller wheel which is located on the raised side of the shopping cart.

The magnetic forces which originate from the “strong” magnetic strip reduce as the distance increases, and the magnetic forces are therefore not sufficient to deactivate again the immobilizer in the roller wheel which is located on the raised side of the shopping cart.

When the “strong” magnetic strip is passed, under the described circumstances only the immobilizer on the roller wheel which was located on the underlying surface is deactivated.

After the customer has passed the “strong” immobilizer, he notices that the immobilizer which is located on the roller wheel which was always in contact with the floor or ground is then deactivated and he places the shopping cart which was raised on one side back on the underlying surface with all its roller wheel wheels.

The immobilizer which is still activated in the wheel which was raised earlier then continues to have an adverse effect on the maneuverability of the shopping cart even though the shopping cart is being moved within the permissible region.

If the shopping cart then travels over a “weak” magnetic strip, the immobilizer in the wheel which was raised earlier is then also deactivated and it becomes possible to maneuver the shopping cart without impedance.

Such a “weak” magnetic strip or a plurality of such “weak” magnetic strips are preferably located at such points within the permissible region of being a high level of probability which have passed by customers, for example in the entry region to the store or in the vicinity of storage points for the shopping carts.

### COMMERCIAL APPLICABILITY

The invention can be applied commercially wherever immobilizers for shopping carts are used, for example retail outlets or wholesale businesses.

1. An immobilizer, which is activated and deactivated by means of magnetic forces which are generated by an external magnetic field and act on the immobilizer, characterized in that
smaller forces which are generated by the external magnetic field are necessary for the deactivation process than the magnetically generated forces which are required for the activation process.

2. The immobilizer as claimed in claim 1, characterized in that
in the activated state of the immobilizer a magnet (7) which is arranged in the interior of the immobilizer assumes a position in which this magnet (7) assists the effect of the magnetically generated forces which act on the immobilizer.

3. The immobilizer as claimed in claim 1 or 2, characterized in that
in the activated state of the immobilizer a magnet (7) which is arranged in the interior of the immobilizer assumes a position in which this magnet (7) is located closer to the magnet (4) which can move under the influence of the magnetic field which acts from the outside.

4. The immobilizer as claimed in claims 1 to 3, characterized in that
in the activated state of the immobilizer a magnet (7) which is arranged in the interior of the immobilizer assumes a position in which this magnet (7) is located closer to the magnet (4), and the magnet (4) and the magnet (7) are arranged in such a way that the two magnets attract one another.
